(19) United States
(12) Patent Application Publication
(10) Pub. No.: US 2026/0210486 A1
(43) Pub. Date: Jul. 23, 2026

(54) SYSTEM TO REMOTELY ADJUST A TELESCOPING DEVICE WITH A TUBE

(71) Applicants: John Garlick, Glendale, CA (US); David Mounts, Sunland, CA (US)

(72) Inventors: John Garlick, Glendale, CA (US); David Mounts, Sunland, CA (US)

(21) Appl. No.: 19/458,145

(22) Filed: Jan. 23, 2026

Related U.S. Application Data
(60) Provisional application No. 63/748,654, filed on Jan. 23, 2025.

(51) Int. Cl. F16M 11/28

(52) U.S. Cl. CPC F16M 11/28

(57) ABSTRACT

A telescoping device is disclosed that enables controlled adjustment of a telescoping shaft using a driven hollow tubular element. The device includes a telescoping shaft having a top end and a bottom end, a casing positioned at the bottom end of the telescoping shaft, and a drive wheel housed within the casing. The drive wheel is operatively coupled to the hollow tubular element and is driven by at least one of a belt or a motor. Rotation of the drive wheel selectively advances the hollow tubular element into the telescoping shaft or retracts the hollow tubular element from the telescoping shaft, thereby extending or contracting the telescoping shaft to adjust its height. In some embodiments, the hollow tubular element houses one or more electrical cables extending through the telescoping shaft. The device provides coordinated mechanical height adjustment and internal cable routing within a compact structure.

### CROSS-REFERENCE TO RELATED APPLICATIONS

The present application claims priority to U.S. Provisional Application No. 63/748,654 filed Jan. 23, 2025, titled “SYSTEM TO REMOTELY ADJUST A TELESCOPING DEVICE WITH A TUBE,” which is hereby incorporated by reference in its entirety.

### TECHNICAL FIELD

The embodiments generally relate to the technical field of mechanically actuated telescoping support devices.

### BACKGROUND

Conventional telescoping support devices are commonly used in applications such as microphone stands, lighting supports, and similar adjustable structures that require vertical positioning of an attached component. These devices typically employ multiple nested tubular sections that slide relative to one another to allow height adjustment. Users often adjust the height manually by loosening a locking mechanism, repositioning the telescoping sections, and reengaging the lock to secure the support at a desired height.

Many conventional systems rely on mechanical locking components such as twist collars, clutch locks, friction fittings, or spring-biased pins to maintain a selected height. While these mechanisms provide stability during use, they generally require direct physical access to the telescoping shaft for adjustment. As a result, height changes may interrupt operation, require manual handling, or necessitate repositioning of attached equipment during adjustment.

Some telescoping support devices incorporate internal cable management to route electrical cables through the interior of the telescoping sections. In these systems, the cables typically move passively as the telescoping sections are extended or retracted. This passive movement can result in slack accumulation, cable binding, or uneven cable distribution within the support structure, particularly during repeated or frequent height adjustments.

Other conventional systems utilize powered or assisted lifting mechanisms to adjust height. These systems often employ rigid drive elements, external cables, or exposed mechanical components to transmit force to the telescoping sections. Such configurations may increase structural complexity, limit compactness, or constrain how internal cables are routed through the support device.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

This disclosure describes a telescoping device that enables controlled adjustment of a telescoping shaft using a driven hollow tubular element. The device includes a telescoping shaft having a top end and a bottom end, a casing positioned at the bottom end of the telescoping shaft, and a drive wheel housed within the casing. The drive wheel is operatively coupled to the hollow tubular element and is driven by at least one of a belt or a motor.

The hollow tubular element extends into the telescoping shaft and is attached to the top end of the telescoping shaft. Rotation of the drive wheel selectively advances the hollow tubular element into the telescoping shaft or retracts the hollow tubular element from the telescoping shaft. This movement causes the telescoping shaft to extend or contract in a controlled manner, thereby adjusting the height of the telescoping device without requiring direct manual manipulation of the telescoping sections.

In some embodiments, the hollow tubular element is configured to house one or more electrical cables extending between the top end and the bottom end of the telescoping shaft. By integrating height adjustment and cable routing into a single hollow tubular element, the device facilitates consistent cable management during extension and retraction of the telescoping shaft. This configuration reduces cable slack variation and maintains a compact and organized internal arrangement as the height of the device changes.

The drive wheel may include a groove that receives and guides the hollow tubular element during rotation, allowing the hollow tubular element to be both pushed and pulled by the drive wheel. Housing the drive wheel and drive mechanism within the casing at the bottom of the telescoping shaft further supports a compact structure and protects the drive components. Collectively, these features provide a mechanically driven telescoping device that enables reliable height adjustment while accommodating internal cable routing in a coordinated manner.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 depicts a variation of the disclosed telescoping device, according to some embodiments;

FIG. 2 depicts a variation of the disclosed telescoping device, according to some embodiments;

FIG. 3 depicts a portion of the disclosed telescoping device, according to some embodiments;

FIG. 4 depicts a portion of the disclosed telescoping device, according to some embodiments;

FIG. 5 depicts a portion of the disclosed telescoping device, according to some embodiments;

FIG. 6 depicts a portion of the disclosed telescoping device, according to some embodiments;

FIG. 7 depicts a variation of the disclosed telescoping device, according to some embodiments; and

FIG. 8 depicts a variation of the disclosed telescoping device, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The embodiments described herein relate to a mechanically actuated telescoping device configured to adjust an overall height of a telescoping shaft through controlled movement of a hollow tubular element. The device may be implemented in applications such as adjustable support structures where vertical positioning and internal cable routing are desired, including microphone stands and similar equipment supports.

The telescoping device may include a telescoping shaft formed from a plurality of elongated tubular sections arranged coaxially with one another. The tubular sections may be sized to nest concentrically so that individual sections slide relative to adjacent sections along a longitudinal axis. This sliding relationship allows the telescoping shaft to extend and retract between a contracted state and an extended state. The telescoping shaft may define an internal passage that extends along at least a portion of its length and is sized to receive a hollow tubular element.

The hollow tubular element may be formed as a flexible or semi flexible tube and may extend through the internal passage of the telescoping shaft. In some embodiments, the hollow tubular element may be constructed from a low friction polymer material such as PTFE, although other materials having suitable flexibility and strength may be used. The hollow tubular element may be attached at or near a top end of the telescoping shaft so that linear movement of the hollow tubular element produces a corresponding change in the relative positions of the telescoping shaft sections. The hollow tubular element may further define an internal lumen sized to receive one or more electrical cables, such as microphone cables, that extend between the top end and a bottom end of the telescoping shaft.

A casing may be positioned at or coupled to the bottom end of the telescoping shaft. The casing may define an internal cavity that houses mechanical components used to drive movement of the hollow tubular element. The casing may be formed as a separate housing secured to the telescoping shaft or may be integrated with a lower portion of the telescoping shaft as a single structural assembly. The casing may provide structural support, alignment, and environmental protection for the internal drive components.

A drive wheel may be disposed within the internal cavity of the casing. The drive wheel may be mounted for rotation about an axis that is oriented substantially perpendicular to the longitudinal axis of the telescoping shaft. The drive wheel may include a circumferential groove, channel, or helical path configured to receive and guide the hollow tubular element. Engagement between the groove and the hollow tubular element allows the drive wheel to apply both pushing and pulling forces to the hollow tubular element during rotation.

A drive mechanism may be operatively coupled to the drive wheel to cause controlled rotation of the drive wheel. The drive mechanism may include an electric motor mounted within the casing and mechanically coupled to the drive wheel either directly or through an intermediate transmission. In some embodiments, the drive mechanism may include a belt that transfers rotational motion from the motor to the drive wheel. In other embodiments, the motor may drive the drive wheel through a direct coupling. The drive mechanism may be configured to rotate the drive wheel in opposing directions to selectively advance the hollow tubular element into the telescoping shaft or retract the hollow tubular element from the telescoping shaft.

During operation, rotation of the drive wheel in a first direction may feed the hollow tubular element into the internal passage of the telescoping shaft. As additional length of the hollow tubular element enters the telescoping shaft, the telescoping shaft sections may extend relative to one another to accommodate the increased internal length. Rotation of the drive wheel in an opposite direction may withdraw the hollow tubular element from the telescoping shaft, causing the telescoping shaft sections to retract as internal length decreases. This coordinated movement allows controlled adjustment of the overall height of the telescoping shaft without requiring manual repositioning of the telescoping sections.

The hollow tubular element may simultaneously function as a mechanical actuator and a cable conduit. Electrical cables housed within the hollow tubular element may move together with the hollow tubular element as it advances or retracts, thereby maintaining a consistent internal cable path during height adjustment. The internal routing of cables through the hollow tubular element may reduce external cable exposure and support organized cable management throughout operation of the telescoping device.

The components described above may be arranged in various configurations while maintaining the functional relationships disclosed herein. Dimensional relationships, material selections, and component geometries may be adapted based on application requirements, load capacities, and environmental considerations. The described structure enables mechanical height adjustment and internal cable routing using coordinated interaction between the telescoping shaft, hollow tubular element, drive wheel, and drive mechanism.

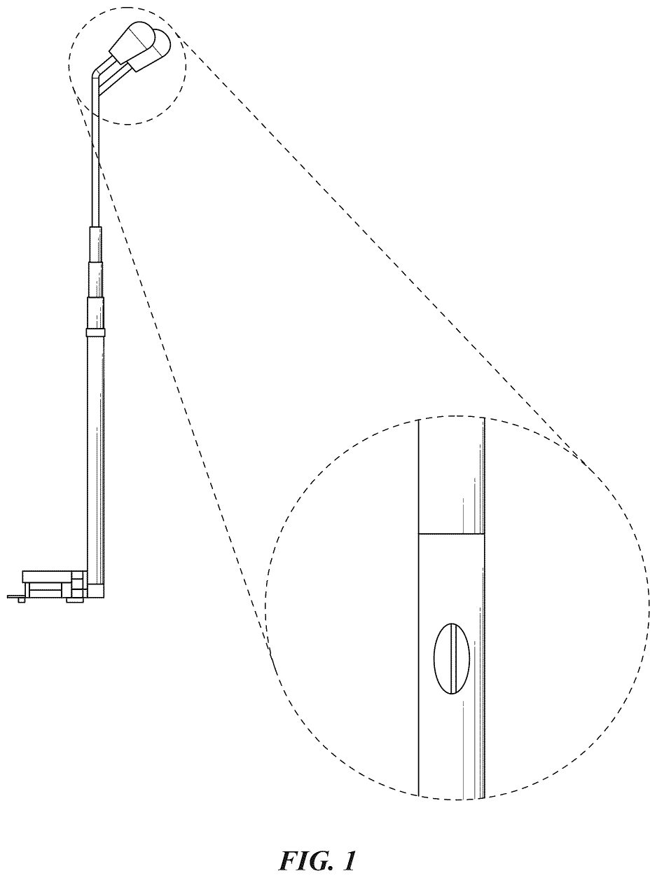

FIG. 1 depicts a variation of the disclosed telescoping device 100 including a telescoping shaft 102 having a bottom end 104 and a top end 106. In some embodiments, the telescoping shaft is a multi-section telescoping shaft. A hollow tubular element 132 extending at least partially within the telescoping shaft 102, the hollow tubular element 132 being attached to the top end 106 of the telescoping shaft 102. Telescoping shaft 102 may define an internal channel 109 therein to house the hollow tubular element 132. The telescoping device 100 may include a casing 110 defining an internal cavity 112 positioned at the bottom end 104 of the telescoping shaft 102. Casing 110 may include a housing secured at a lower portion of the telescoping shaft to attached the bottom end 104 to a drive mechanism or powered drive assembly.

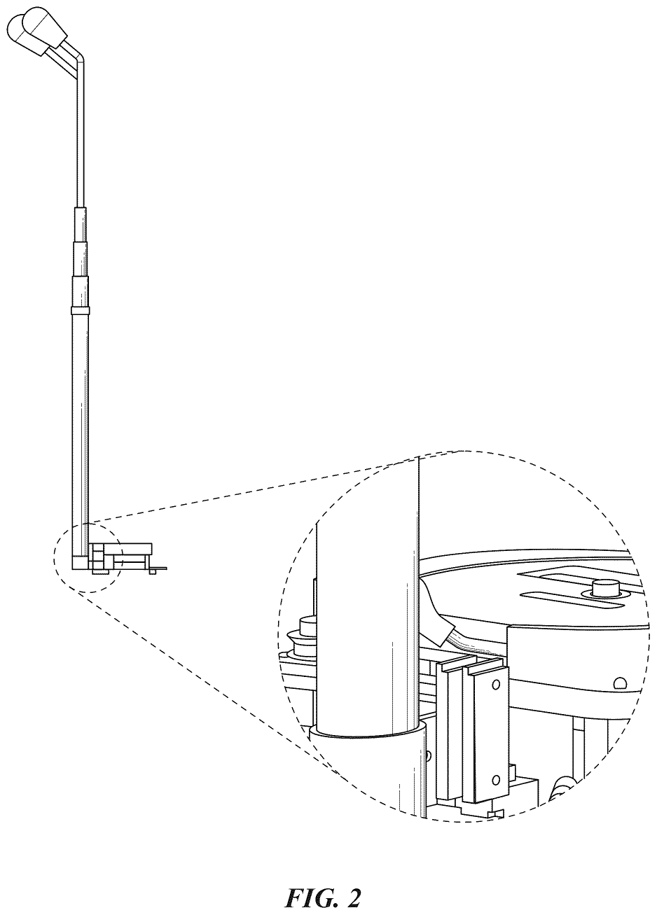

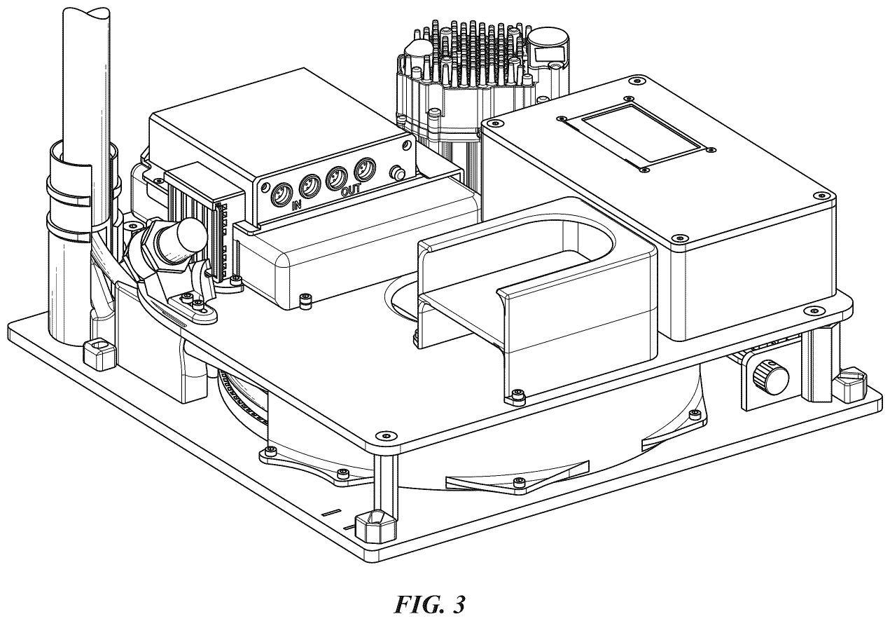

FIGS. 2 and 3 depict variations of the disclosed telescoping device 100 including a casing 110 defining an internal cavity 112 positioned at the bottom end 104 of the telescoping shaft 102; a drive wheel 114 disposed within the internal cavity 112 and operatively coupled to the hollow tubular element 132; and a drive mechanism 120 comprising at least one of a belt (best shown in FIG. 6 as belt 118) or a motor 130 configured to rotate the drive wheel 114, wherein rotation of the drive wheel causes the hollow tubular element to be selectively advanced into or withdrawn from the telescoping shaft to adjust a height of the telescoping shaft. Belt 118 may be in mechanical communication with motor 130 and drive wheel 114, such that rotation of the drive wheel 114 causes the hollow tubular element to be selectively advanced into or withdrawn from the telescoping shaft to adjust a height of the telescoping shaft.

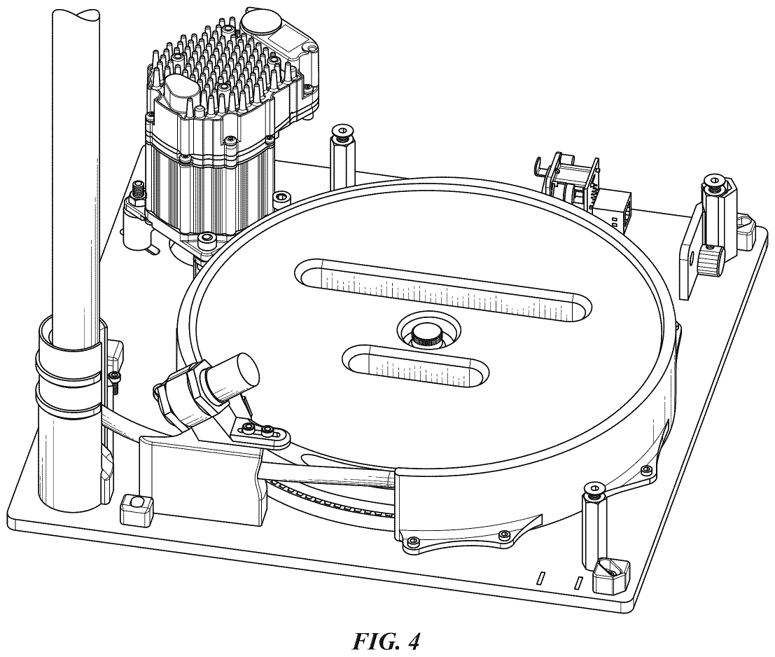

FIG. 4 depicts portions of a variation of the disclosed drive mechanism 120 or powered drive assembly comprising at least one of a belt (not shown) or a motor configured to rotate the drive wheel 114, wherein rotation of the drive wheel 114 causes the hollow tubular element to be selectively advanced into or withdrawn from the telescoping shaft to adjust a height of the telescoping shaft. The drive mechanism 120 may also be in mechanical communication with a hollow tubular element 132 removably wrapped around the drive wheel 114 such that, when the hollow tubular element is selectively advanced into or withdrawn from the telescoping shaft, the hollow tubular element 132 also is selectively advanced into or withdrawn from the telescoping shaft. Drive wheel 114 may be at least partially housed within wheel housing 134 secured to base 136.

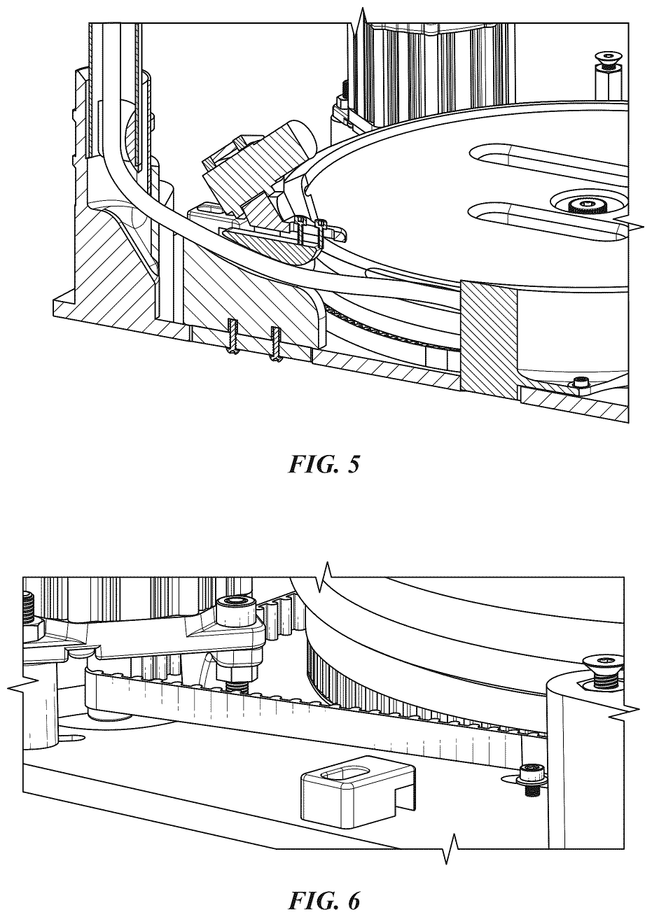

FIG. 5 depicts a cut-away view of the drive mechanism in mechanical communication with a hollow tubular element 132 removably coiled around the drive wheel 114 such that, when the hollow tubular element 132 is selectively advanced into or withdrawn from the telescoping shaft 102, the hollow tubular element 132 also is selectively advanced into or withdrawn from the telescoping shaft 102 driven by rotation of the drive wheel 114 driven via motor 130 via belt (best shown in FIG. 6 as belt 118).

FIG. 6 depicts the belt 118 mechanically coupled to a drive shaft of the motor 130 and the drive wheel 114. Drive wheel 114 may have hollow tubular element 132 removably wrapped around the drive wheel 114 such that, when the hollow tubular element is selectively advanced into or withdrawn from the telescoping shaft via belt 118 movement, the hollow tubular element 132 also is selectively advanced into or withdrawn from the telescoping shaft. Drive wheel 114 may be at least partially housed within wheel housing 134.

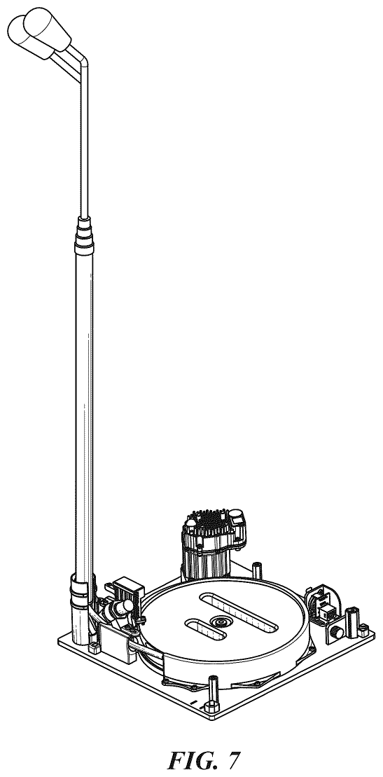

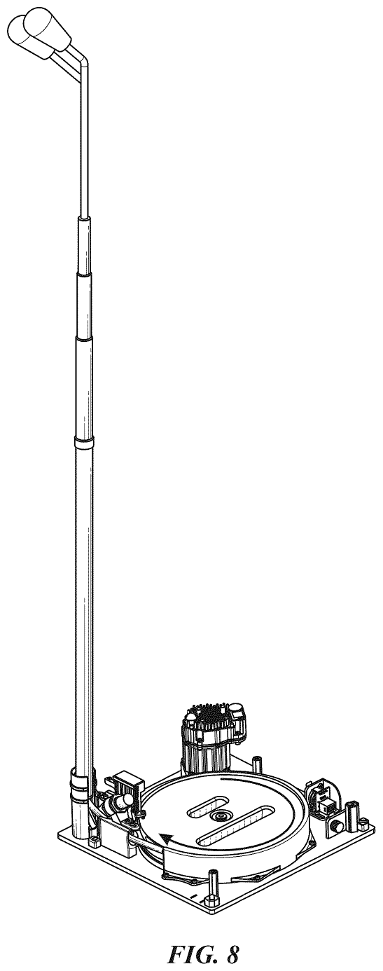

FIG. 7 depicts the telescoping device 100 including a telescoping shaft 102 in a retracted position. FIG. 8 depicts the telescoping device 100 including a telescoping shaft 102 in an extended position, wherein telescoping shaft 102 has extended portions 102a, 102b, 102n, which may consist of any number or shaft portions, such that top end 106 may be raised and lowered via movement of the drive wheel 114 and driving of the hollow tubular element 132 within the telescoping shaft 102.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A telescoping device comprising:
a telescoping shaft having a bottom end and a top end;
a hollow tubular element extending at least partially within the telescoping shaft, the hollow tubular element being attached to the top end of the telescoping shaft;
a casing defining an internal cavity positioned at the bottom end of the telescoping shaft;
a drive wheel disposed within the internal cavity and operatively coupled to the hollow tubular element; and
a drive mechanism comprising at least one of a belt or a motor configured to rotate the drive wheel, wherein rotation of the drive wheel causes the hollow tubular element to be selectively advanced into or withdrawn from the telescoping shaft to adjust a height of the telescoping shaft.

2. The telescoping device of claim 1, wherein the hollow tubular element is constructed and arranged to house one or more electrical cables extending between the top end and the bottom end of the telescoping shaft.

3. The telescoping device of claim 1, wherein the drive wheel includes a groove configured to receive and guide the hollow tubular element during rotation of the drive wheel.

4. The telescoping device of claim 1, wherein the drive mechanism comprises an electric motor mounted within the casing and mechanically coupled to the drive wheel.

5. The telescoping device of claim 1, wherein the drive wheel is oriented such that a rotational axis of the drive wheel is substantially perpendicular to a longitudinal axis of the telescoping shaft.

6. The telescoping device of claim 1, wherein advancement of the hollow tubular element into the telescoping shaft causes extension of the telescoping shaft and withdrawal of the hollow tubular element causes contraction of the telescoping shaft.

7. The telescoping device of claim 1, wherein the telescoping shaft defines an internal passage sized to receive the hollow tubular element.

8. A remotely adjustable telescoping apparatus comprising:
a multi-section telescoping shaft;
a flexible hollow tube attached at an uppermost section of the telescoping shaft;
a housing secured at a lower portion of the telescoping shaft;
a rotatable drive wheel located within the housing and engaging the flexible hollow tube; and
a powered drive assembly configured to rotate the drive wheel, wherein rotation of the drive wheel selectively feeds the flexible hollow tube into the telescoping shaft or retracts the flexible hollow tube from the telescoping shaft to change an overall length of the telescoping shaft.

9. The telescoping apparatus of claim 8, wherein the flexible hollow tube is formed from a low-friction polymer material.

10. The telescoping apparatus of claim 8, wherein the flexible hollow tube encloses at least one microphone cable extending through the telescoping shaft.

11. The telescoping apparatus of claim 8, wherein the drive assembly comprises a belt coupled between the drive wheel and a motor.

12. The telescoping apparatus of claim 8, wherein the housing is integrated with the lower portion of the telescoping shaft as a single assembly.

13. The telescoping apparatus of claim 8, wherein the drive wheel includes a helical or corkscrew-shaped channel that receives the flexible hollow tube.

14. The telescoping apparatus of claim 8, wherein the telescoping shaft is configured for use as a microphone stand.

15. A height-adjustable support device comprising:
an elongated telescoping column;
a hollow tubular member secured to an upper end of the telescoping column;
a base housing coupled to a lower end of the telescoping column;
a rotatable member disposed within the base housing and engaging the hollow tubular member; and
an actuator configured to rotate the rotatable member, wherein rotation of the rotatable member causes linear movement of the hollow tubular member relative to the telescoping column, thereby extending or retracting the telescoping column.

16. The height-adjustable support device of claim 15, wherein the hollow tubular member is configured to simultaneously transmit a pushing force to extend the telescoping column and a pulling force to retract the telescoping column.

17. The height-adjustable support device of claim 15, wherein the actuator comprises an electric motor.

18. The height-adjustable support device of claim 15, wherein the hollow tubular member extends through an interior of the telescoping column from the base housing to the upper end.

19. The height-adjustable support device of claim 15, wherein the rotatable member comprises a wheel having a circumferential groove that captures the hollow tubular member.

20. The height-adjustable support device of claim 15, wherein the telescoping column comprises a plurality of nested tubular sections movable relative to one another in response to movement of the hollow tubular member.
